(19) United States
(12) Patent Application Publication
(10) Pub. No.: US 2008/0319669 A1
(43) Pub. Date: Dec. 25, 2008

(54) System and Device Used to Automatically Determine the Position of an Entity with Respect to Two or More Reference Entities in Real Time

(76) Inventor: Cesare Mattoli, Foligno (IT)

Correspondence Address: HODES, PESSIN & KATZ , P.A, 901 DULANEY VALLY ROAD , SUITE 400, BALTIMORE, MD, 21204, US

(21) Appl. No.: 11/658,756

(22) PCT Filed: Jul. 21, 2005
(86) PCT No.: PCT/IT2005/000426

§ 371 Date: Jan. 26, 2007

(30) Foreign Application Priority Data
Jul. 26, 2004 (IT) MC2004A00100

(51) Int. Cl. G06F 17/10

(52) U.S. Cl. 701/300

(57) ABSTRACT

The present industrial invention refers to a system and device used to automatically determine the position of an entity with respect to two or more reference entities; the said system is based on the transmission of two consecutive coded signals, with pre-determined time interval, by a reference source. The first signal is sent by means of radio waves and the second signal by means of acoustic waves; the second signal is followed by an acoustic signal emitted by another reference entity after a present time interval.

The present patent application for industrial invention refers to a system and a device used to automatically determine the position of an entity with respect to two or more reference entities in real time.

In case of a mobile entity, the periodical determination of its position by the system and device of the invention allows to calculate other parameters and units, such as the speed or direction of the mobile entity, by means of a suitable known data processing techniques.

With respect to other equivalent systems, the system and device of the invention are characterised by higher measurement accuracy and simpler installation.

In addition to accurate distance calculation, the other purposes of the invention include, for instances, to devise a detection system that makes use of a simple, easy-to-make device, also in portable version, which can be used whenever accurate fast topographical measurements are needed, such as in case of a car accident.

The system of the invention is based on the transmission of two consecutive coded signals, with pre-determined time interval, by a reference source. The first signal is broadcast by means of radio waves and the second signal by means of acoustic waves; the second signal is followed by an acoustic signal emitted by a reference entity after a preset time interval.

According to the system of the invention, the mobile entity is provided with a processing device that calculates the distance of the entity from the transmission source starting from the measurement of the time interval elapsed between the reception of the two consecutive signals and the next signal emitted by the other reference source in real time and automatically, calculating its position on the plane.

For major clarity the description of the system and device according to the invention continues with reference to the enclosed drawings, which are intended for purposes of illustration only and not in a limiting sense, whereby

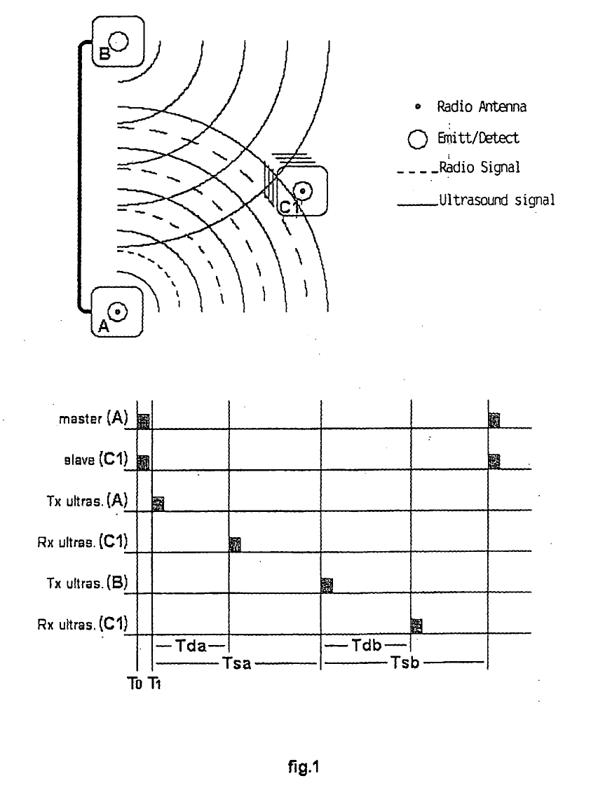

FIGS. 1 to 4 are diagrammatic views of the device of the invention in four different embodiments, combined with a chart showing the sequence of signals emitted and/or received by the different entities of the device.

According to the first embodiment, the device of the invention includes:

first station A (primary station) composed of a radio-digital signal communication device (radio modem—master) and one ultrasound signal emitter;

one second station B electrically connected with station A, composed of one ultrasound signal emitter;

one mobile entity C1 provided with radio digital communication device (radio modem—slave), one ultrasound signal detector, one chronometer and one electronic data processing and calculation device used to calculate the position of entity C1 with respect to stations A and B.

According to the system of the invention, station A—which operates as primary station of a generic communication system (master)—sends the first signal (radio-digital) starting from time T0 with a specific command code and after time interval T1 predefined and known by C1 sends the second (ultrasound) signal.

The first signal (radio-digital) and the second signal (acoustic) are intercepted by entity C1 (slave) that interprets time T1 from the radio signal and calculates time interval Tda between time T1 and the acoustic signal from station A (without taking into consideration successive signals produced by echoes or rebounds) to accurately determine its distance from station A.

Moreover, according to the system of the invention, after a predefined time interval Tsa starting from time T1, station A sends another acoustic signal by means of an ultrasound emitter installed in station B. The acoustic signal is intercepted by entity C1, which calculates its distance from station B, starting from measurement of time interval Tdb between time T1 and the first ultrasound acoustic signal after Tsa (without taking into consideration following signals), subtracting constant time Tsa that must be also known by C1.

In this preferred embodiment of the device of the invention, the second station B is electrically connected with the first station A, in such a way that the ultrasound signal emitter installed in station B receives the signals sent by station A via cable.

Once coordinates of stations A and B are fixed in a reference plane, entity C1 can determine its position in the reference plane by means of suitable geometrical calculations, as long as it is always on the same side with respect to stations A and B.

Time interval Tsa must be higher or equal to the time needed by the acoustic signal emitted by station A to reach entity C1 and, if necessary, increased by the absorption time of echoes, if any.

In case of a moving entity C1, according to the system of the invention, after an additional time interval Tsb, the sequence of emitted signals can be repeated cyclically to allow mobile entity C1 to automatically determine its position time after time, and consequently determine its direction and speed.

Time interval Tsb must be higher or equal to the time needed by the acoustic signal emitted by station B to reach the mobile entity C1 and, if necessary, increased by the absorption time of echoes, if any.

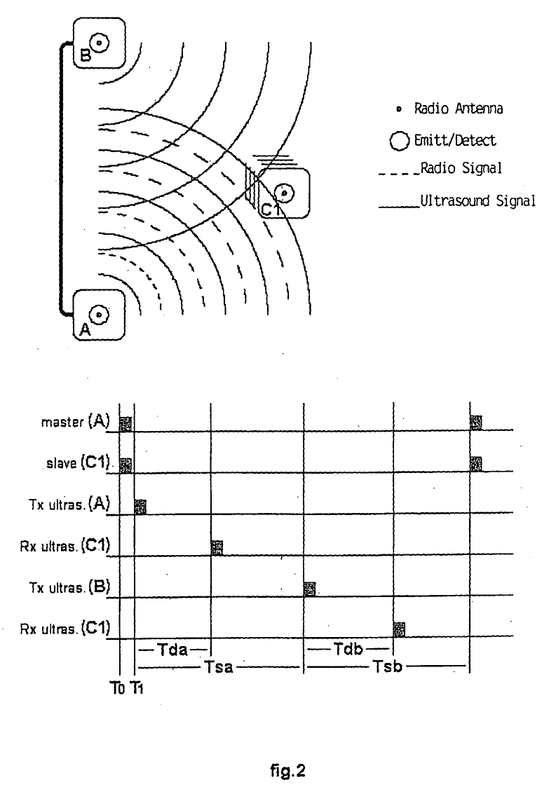

If high accuracy over long distances are required, the variation of sound speed in the air is not negligible. In this case, it may be useful to measure the speed of sound in the air, adding an ultrasound detector in station B, as diagrammatically shown in FIG. 2, in order to measure the acoustic propagation time between the two reference stations (that is to say at known distance) and communicate this piece of information to entity C1 for correction.

If the device is used on an occasional basis in different places, the electrical connection between stations A and B may be uncomfortable.

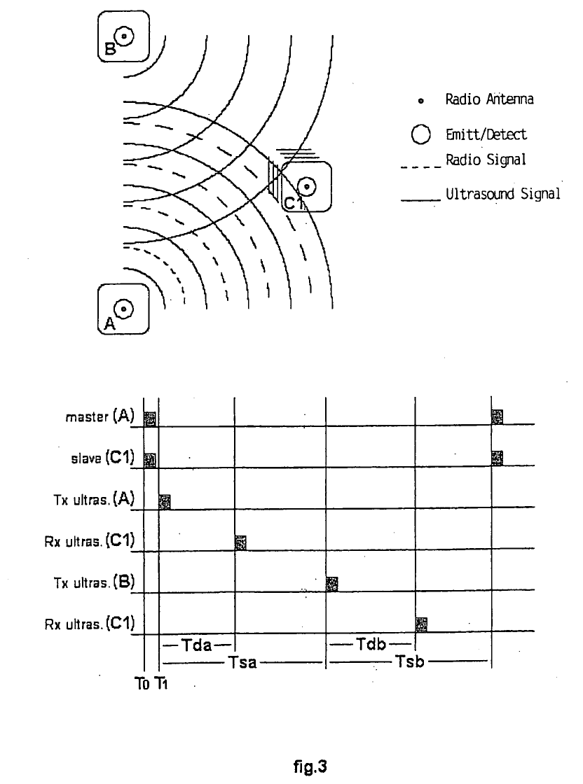

In this case, as shown in FIG. 3, an autonomous communication system is installed in station B, which is configured as secondary (slave), intercepts the radio signal from station A, interprets time T1 and consequently sends the ultrasound acoustic signal after time Tsa.

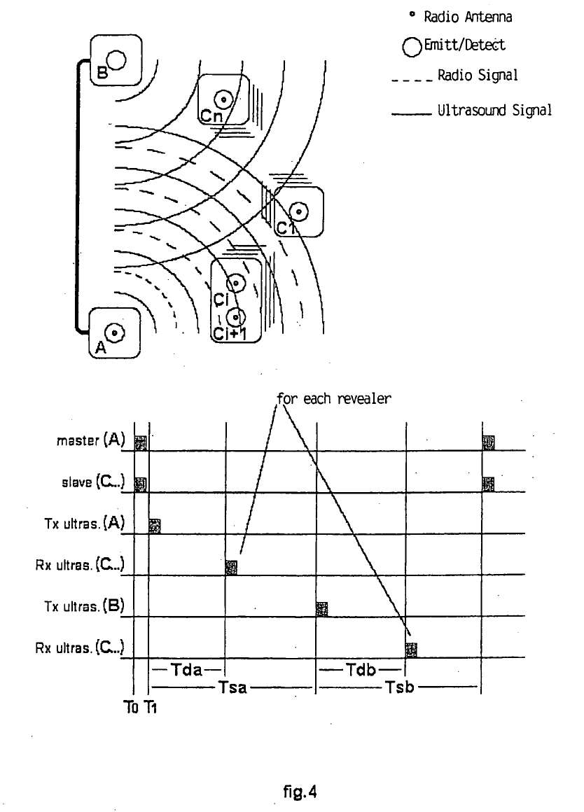

Being stations A and B the only ultrasound emitters, no interference problems exist in case of an unlimited number of entities (C1-Cn), as shown in FIG. 4, each entity being capable of determining its position without any limitations; moreover, by installing two ultrasound signal detectors (Ci and Ci+1) in the same entity, the angular position of the said entity can also be determined when standing.

By adding a third reference station, which does not belong to the plane formed by the first two stations A and B and the mobile entity or entities, the latter can detect their position in the space. From the functional viewpoint, the third reference station emits the ultrasound signal after a suitable time interval known by the mobile entity or entities.

When higher security is required or when it is necessary to discriminate whether the mobile entity is always on the same side with respect to the reference stations, it is necessary to increase the number of the said stations that will send the relevant ultrasound signals at suitable time intervals known by the mobile entity or entities.

1) System used to automatically determine the position of an entity with respect to two or more reference entities in real time, characterised in that it makes use of a device comprising:
one first station A (primary station) composed of a radio-digital signal communication device (radio modem—master) and one ultrasound signal emitter;
one second station B electrically connected with station A, composed of one ultrasound signal emitter;
one mobile entity C1 provided with radio digital communication device (radio modem—slave), one ultrasound signal detector, one chronometer and one electronic data processing and calculation device, used to interpret time T1, calculate the distance of entity C1 with respect to stations A and B and process the said distance to obtain the relevant position;
and also characterised in that:
station A sends the first signal (radio-digital) starting from time T0 with a specific command code and sends the second (ultrasound) signal after time interval T1 predefined and known by C1;
after measuring time interval Tda between time T1 and the second signal sent by station A, entity C1 calculates its distance from station A;
after a predefined time interval Tsa starting from time T1, station A sends another acoustic signal by means of an ultrasound emitter installed in station B;
entity C1 calculates its distance from station B, starting from measurement of time interval Tdb between time T1 and the first ultrasound acoustic signal after Tsa, subtracting constant time Tsa that must be also known by C1.

2) Device for the execution of the system as defined in the preceding claim, characterised in that the second station B is electrically connected to the first station A.

3) Device for the execution of the system as defined in claim 1 characterised in that the second station B is provided with an autonomous communication system used to intercept the radio signal from station A, calculate time T1 and consequently send an ultrasound acoustic signal after time Tsa.

4) System used to automatically determine the position of an entity with respect to two reference entities in real time, as defined in claim 1, characterised in that after a time interval Tsb, starting from the emission of the acoustic signal sent by station B, the sequence of emitted signals is repeated cyclically to allow mobile entity C1 to automatically determine its position time after time and consequently determine its direction and speed.

5) System used to automatically determine the position of an entity with respect to two reference entities in real time, as defined in claims 1 and 4, characterised in that it operates with an unlimited number of entities (C1-Cn).

6) System used to automatically determine the position of an entity with respect to two reference entities in real time as defined in claim 5, characterised in that two ultrasound signal detectors (Ci and Ci+1) are installed on the same entity in order to calculate the angular position of the entity, including when standing.

7) System used to automatically determine the position of an entity with respect to two reference entities in real time as defined in one or more of claims 1, 4, 5 and 6, characterised in that entities C1-Cn automatically determine their position on a reference plane, where coordinates of stations A and B are known.

8) System used to automatically determine the position of an entity with respect to two reference entities in real time as defined in one or more of claims 1, 4, 5, 6 and 7, characterised in that it makes use of a third reference station, which does not belong to the plane passing through the two stations A and B and entity or entities C1-Cn, in such a way that the latter can determine their position in the space, it being provided that the third station sends the ultrasound signal after a suitable time interval known to entity or entities C1-Cn.
